(19) United States
(12) Patent Application Publication
(10) Pub. No.: US 2012/0217258 A1
(43) Pub. Date: Aug. 30, 2012

(54) Method and Apparatus for Hairstyling

(76) Inventor: George Pasquale DeSopo, Metairie, LA (US)

(21) Appl. No.: 13/403,154

(22) Filed: Feb. 23, 2012

Related U.S. Application Data
(60) Provisional application No. 61/446,228, filed on Feb. 24, 2011.

(51) Int. Cl. A45D 97/00; B65G 59/00

(52) U.S. Cl. 221/1

(57) ABSTRACT

A pouch holder provides for convenient dispensing of thin sheets of foil commonly used in the treatment of hair. The holder may be worn about a hair stylist's neck or placed in another location that is easily accessible a stylist. A gripper device, which can be optionally attached to a stylist's comb or other instrument, is used to easily and efficiently pull individual sheets from the holder.

### CROSS REFERENCES TO RELATED APPLICATION

Priority of U.S. Provisional Patent Application Ser. No. 61/446,228, filed Feb. 24, 2011, incorporated herein by reference, is hereby claimed.

### STATEMENTS AS TO THE RIGHTS TO THE INVENTION MADE UNDER FEDERALLY SPONSORED RESEARCH AND DEVELOPMENT

None

### BACKGROUND OF THE INVENTION

1. Field of the Invention

The present invention relates to a method and apparatus for hair styling. More particularly, the present invention relates to a flat, pouch-like holder that provides for convenient dispensing of thin sheets commonly used by hair stylists to bleach, color, or otherwise treat hair.

2. Brief Description of the Prior Art

Coloring, bleaching and highlighting hair comprise some of the most common tasks performed by hair stylists. To accomplish these and other tasks, stylists frequently employ sheets of foil or other thin material to wrap or otherwise affix to hair at various stages of the treatment process. When such sheets are stacked for use one at a time—which is a common practice among hair stylists—said sheets often clump and/or stick together, making it difficult to manually separate a single sheet from the stack. This difficulty is compounded when the stylist holds a comb and/or other styling instrument in his or her hand(s).

Further, when such a stack of sheets is placed on a table, tray, counter or other supporting surface, the stylist may be forced to reach awkwardly over or around the client. The resulting physical contact—or narrow aversion of physical contact—may be negatively perceived by the client. Alternatively, the client may be required to remove sheets from a stack and then hand said sheets to a stylist for use, which can also be negatively perceived by many clients.

Repeatedly reaching for, grabbing and separating of dozens of individual sheets slows and unnecessarily complicates the treatment process. For the commercial stylist, time is of the essence; anything that slows the treatment process has an adverse effect on the stylist's efficacy and, by extension, his or her potential compensation.

Additionally, unnecessary delays can negatively impact the treatment process itself. In many cases, in order to achieve the most even application, the bleach, dye and/or the foil wraps must all be applied to the hair for a specific length of time. If wraps are left on the hair for disproportionate lengths of time, the results can be extremely uneven and aesthetically unacceptable.

It follows that any invention that reduces the total amount of time required to complete a treatment benefits both stylist and customer in several ways. The present invention shortens and simplifies the task of treating hair by making a stack of sheets more accessible to a stylist, as well as making it easier for a stylist to separate individual sheets.

### SUMMARY OF THE PRESENT INVENTION

In the preferred embodiment, the present invention comprises a method and apparatus for convenient, efficient and effective dispensing of sheets used in the hair styling process. By way of illustration, but not limitation, said sheets can comprise foil sheets commonly used in the hair highlighting and/or coloring process. The method of the present invention utilizes a substantially flat or planar holder which defines at least one pouch for receiving a plurality of foil sheets. Said sheets can be oriented in a configuration such that the top sheet faces slightly outward from the pouch of said holder. Said holder may include a flap to hold such sheets in place within said pouch.

Although said holder may be placed in any convenient location that is easily accessible to a stylist, benefit is frequently gained when said holder is disposed against the stylist's body—for example, suspending the holder from a strap around the stylist's neck so that the holder lies substantially flat against the stylist's torso.

A stylist may simply use his or her hand to withdraw individual sheets from the holder as needed. However, in the preferred embodiment, the stylist will employ a gripper device to efficiently pull single sheets from said holder. Although said gripper device can have many different configurations, in the preferred embodiment said gripper device has a sticky or tacky surface that can be used to pull a single sheet from the stack of sheets received in the pouch of said holder. For maximum benefit and convenience to a stylist, said gripper device may be directly attached to the end of a comb or other instrument commonly held and used by a stylist.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed. Further, dimensions, materials and part names are provided for illustration purposes only and not limitation.

FIG. 1 depicts a perspective view of the apparatus of the present invention being used by a stylist while working on the hair of customer.

FIG. 2 depicts an exploded view of a sheet holder assembly of the present invention.

FIG. 3 depicts an exploded view of a gripper assembly of the present invention.

FIG. 4 depicts a perspective view of a gripper assembly making contact with a top sheet from a holder assembly of the present invention.

FIG. 5 depicts a perspective view of a gripper assembly pulling a top sheet from a holder assembly of the present invention.

FIG. 6 depicts a perspective view of a gripper assembly gripping a top sheet taken from a holder assembly of the present invention

FIG. 7 depicts a side view of a gripper assembly of the present invention, attached to the end of a comb.

FIG. 8 depicts a side sectional view of a gripper assembly of the present invention, attached to the end of a comb.

FIG. 9 depicts a side sectional view of an upper portion of a holder assembly of the present invention.

FIG. 10 depicts a side sectional view of a lower portion of a holder assembly of the present invention.

### DETAILED DESCRIPTION OF A PREFERRED EMBODIMENT OF THE INVENTION

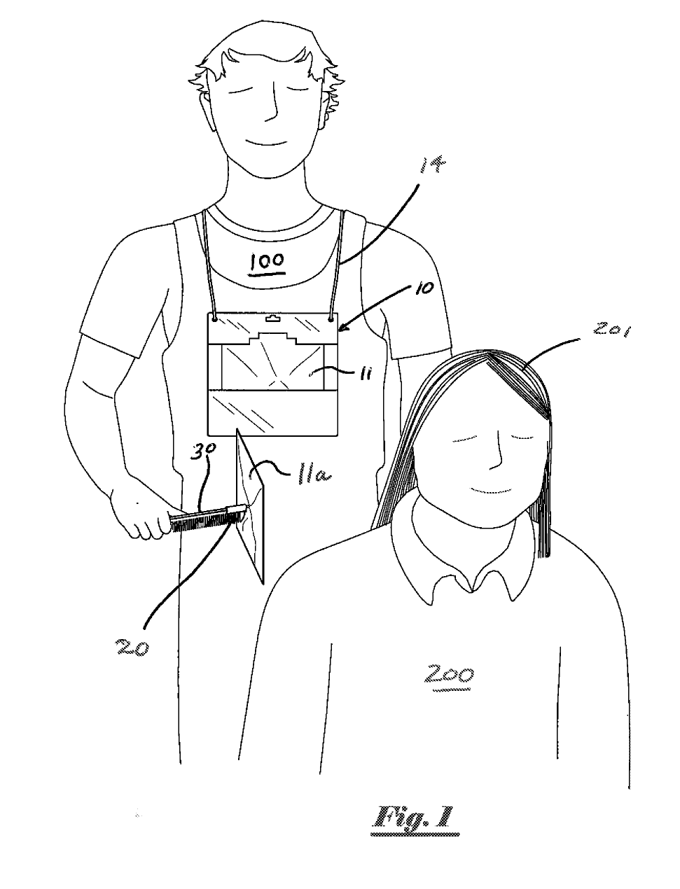

Referring to the drawings, FIG. 1 depicts a perspective view of the apparatus of the present invention being used by stylist 100 while working on hair 201 of customer 200. It is to be observed that stylist 100 may be located in any number of positions relative to customer 200; however, as depicted in FIG. 1, stylist 100 is depicted in a standing position generally behind customer 200 who is depicted in a seated position in a conventional “salon chair” or the like.

In the preferred embodiment, holder assembly 10 is disposed substantially against the front torso of stylist 100. Said holder assembly 10 is substantially planar and contains a plurality of stacked individual sheets 11. Although said sheets 11 can be pre-cut metal sheets routinely used in hair coloring and/or highlighting processes, it is to be observed that the method and apparatus of the present invention can also be used with sheets made of other material including, without limitation, paper, plastic or foam.

As depicted in FIG. 1, holder assembly 10 is suspended around the neck of stylist 100 using flexible cord 14 so that holder assembly 10 rests comfortably at a beneficial and convenient location on the torso of stylist 100. The length of flexible cord 14 can be adjusted to move holder assembly 10 to a position that is comfortable and easily accessible to stylist 100.

Still referring to FIG. 1, gripper assembly 20 is attached to the distal end of comb 30 held by stylist 100. Said gripper assembly 20 can be conveniently used to grab sheet 11a in a manner described more fully below. After said sheet (11a) is removed from the stack and used in the styling process or otherwise disposed of, a new sheet will typically be required. Stylist 10 can use gripper device 20 to conveniently pull the next (top) sheet from the stack of sheets 11 held by holder assembly 10.

Said gripper assembly 20 is depicted herein for illustration purposes as being used in connection with a comb 30, which is a common instrument held by many stylists. However, it is to be observed that said gripper assembly 20 can be configured as a separate item held by a stylist (that is, apart from comb 30), disposed on a thimble or other device, or attached to any number of different items commonly used by stylist such as, for example, scissors, clippers, brushes or the like, without departing from the scope of the present invention.

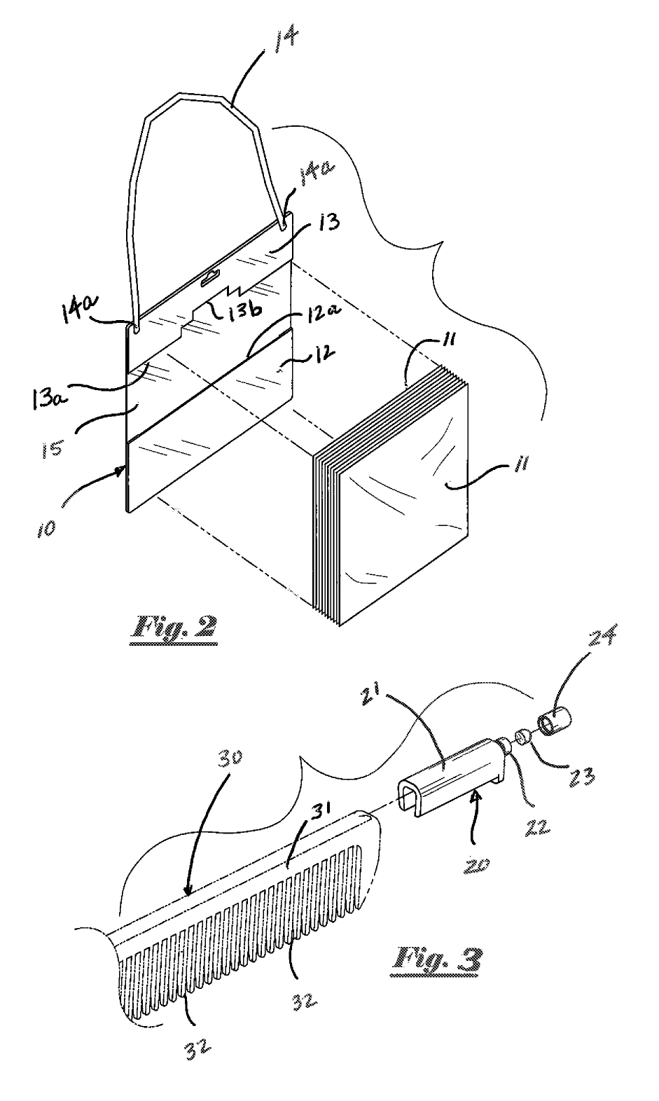

FIG. 2 depicts an exploded view of holder assembly 10 having a plurality of sheets 11 stacked or loaded within said holder assembly 10. In the preferred embodiment, said holder assembly 10 comprises substantially planar backing member 15 which is sufficiently rigid to maintain a substantially flat shape of holder assembly 10. Lower flap member 12 having upper edge 12a is disposed near the bottom of holder assembly 10 and cooperates with backing member 15 to form a pouch or pocket for holding sheets 11. Upper flap member 13 having edge 13a is disposed near the upper portion of holder assembly 10. The upper portion of sheets 11 held within the pocket or pouch formed by lower flap member 12 and backing member 15 can be tucked under said upper flap member 13 to secure said sheets 11 in place and prevent unwanted movement of said sheets 11 held by holder assembly 10. In one embodiment, upper flap member 13 can have cut-out section 13b.

Flexible cord member 14 having ends 14a is connected to holder assembly 10 at said ends 14a. Said flexible cord member 14, which can be a string, rope, wire, strap or other member having similar characteristics, forms a loop that can be used to suspend holder assembly 10 around the neck of a stylist, such as stylist 100 depicted in FIG. 1. It is to be observed that holder assembly 10 can be attached to or worn by a stylist using methods other than flexible cord 14 without departing from the scope of the present invention.

In an alternative embodiment, it is to be observed that holder assembly 10 can have a plurality of pouches or pockets for holding multiple stacks of sheets. Said sheets can be made of different materials and/or can have different pre-formed dimensions. By way of illustration, but not limitation, said alternative holder assembly can have a first pocket or pouch for holding aluminum foil sheets, and a second pocket or pouch for holding smaller paper sheets. Said alternative embodiment allows greater versatility, in that a stylist can access multiple types and/or sizes of sheets during the hair treatment process without having to change holders or refill the existing holder with different sheets.

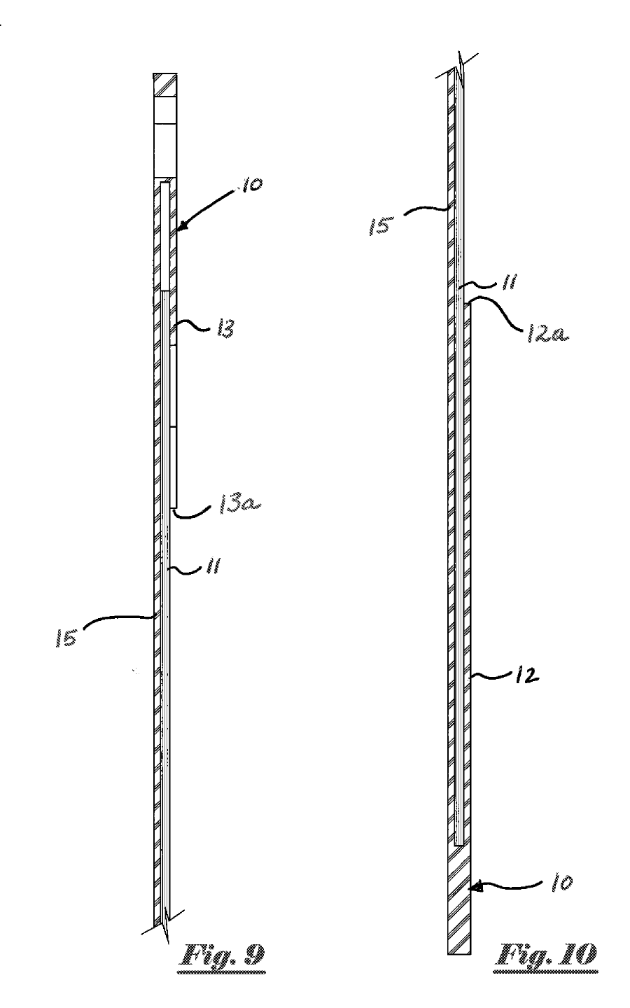

FIG. 9 depicts a side sectional view of an upper portion of a sheet holder assembly 10 of the present invention, while FIG. 10 depicts a side sectional view of a lower portion of said sheet holder assembly 10 of the present invention. Holder assembly 10 comprises substantially planar backing member 15 which is sufficiently rigid to maintain a substantially flat shape of holder assembly 10. Referring to FIG. 10, lower flap member 12 having upper edge 12a is disposed near the bottom of holder assembly 10 and cooperates with backing member 15 to form a pouch or pocket for receiving sheets 11. Referring to FIG. 9, upper flap member 13 having edge 13a is disposed near the upper portion of holder assembly 10. The upper portion of sheets 11 received within the pocket or pouch formed by lower flap member 12 and backing member 15 can be tucked under said upper flap member 13 to secure said sheets 11 in place in a substantially flat stack configuration while preventing undesired movement of said sheets 11.

Referring back, FIG. 3 depicts an exploded view of a gripper assembly 20 of the present invention which can be attached to the distal end of a conventional comb 30 having rigid spine member 31 and a plurality of teeth 32. In the preferred embodiment, gripper assembly 20 comprises connection bracket member 21 having end receptacle 22. As depicted in FIG. 3, connection bracket member 21 forms a channel that can be received on spine member 31 of comb 30 at or near the distal end of said spine member 31. Tacky substance 23 can be disposed within end receptacle 22. Removable cap member 24 can cover and protect tacky substance 23 from unwanted contact during periods of non-use. Removable cap member 24 can have a diameter that is sized to form a frictional connection around end receptacle 22 so that it can remain in place when installed over tacky substance 23.

FIG. 7 depicts a side view of gripper assembly 20, attached to the distal end of comb 30 having rigid spine member 31 and a plurality of teeth 32. Connection bracket member 21 forms a channel that is received on spine member 31 of comb 30 at or near the distal end of said spine member 31. Tacky substance 23 is disposed within end receptacle 22. In the view depicted in FIG. 7, cap member 24 (not depicted in FIG. 7) has been removed. Depending upon the specific material utilized, tacky substance 23 may erode or wear away over time; in such event, tacky substance 23 can be refilled or replaced within end receptacle 22.

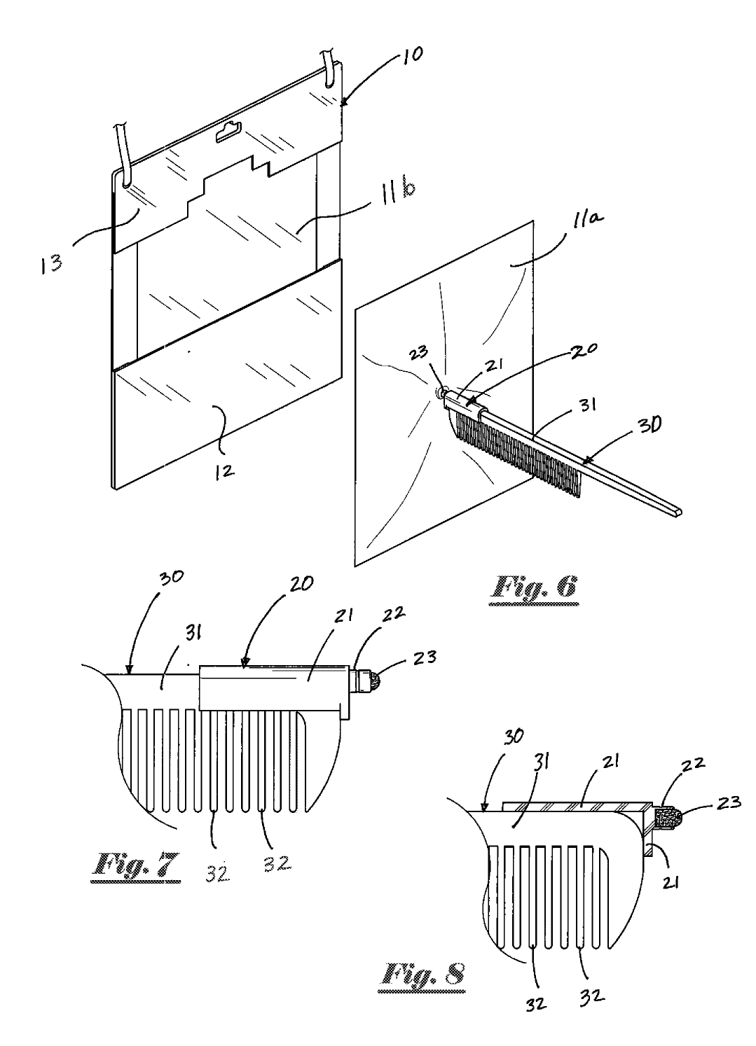

FIG. 8 depicts a side sectional view of gripper assembly 20 and comb 30 depicted in FIG. 7. Connection bracket member 21 forms a channel that is received on spine member 31 of comb 30 at or near the distal end of said spine member 31. Tacky substance 23 is disposed within end receptacle 22, but should beneficially protrude at least partially out of end receptacle 22. Tacky substance 23, which can comprise any number of different materials exhibiting the desired properties and characteristics, should comprise an easily releasable, pressure sensitive adhesive material that can adhere to sheets 11, while permitting fast and easy removal from said sheets without any significant residue or other material remaining on said sheets 11.

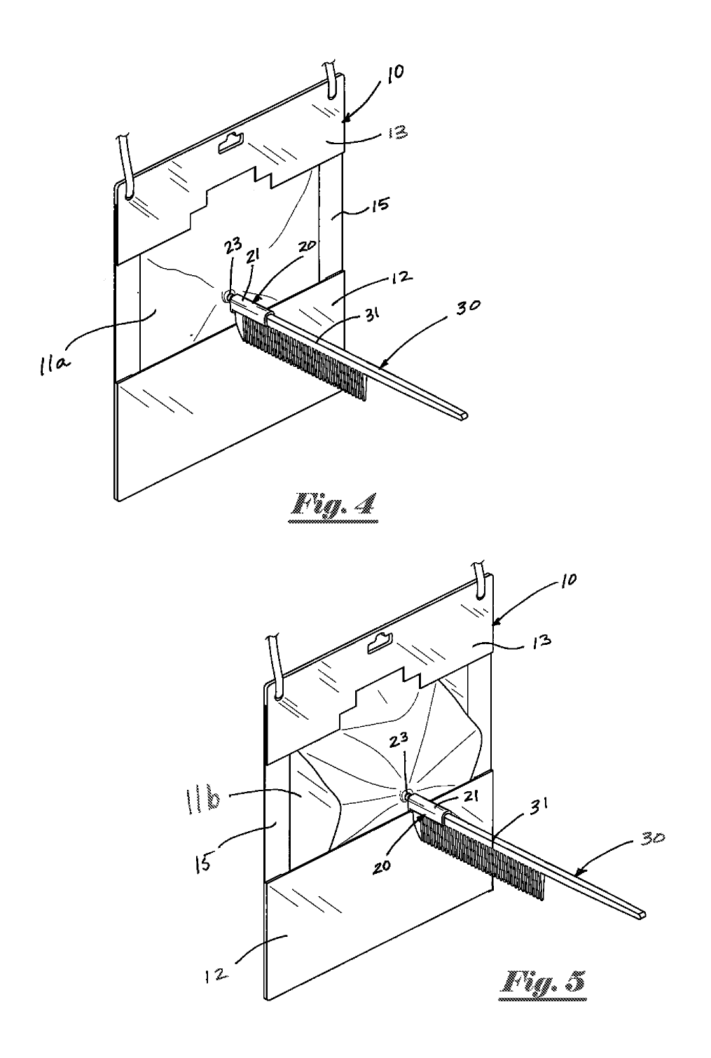

FIGS. 4 through 6 depict side perspective sequential views of gripper assembly 20 being used to remove a sheet 11a from holder assembly 10 according to the method of the present invention.

FIG. 4 depicts a side perspective view of gripper assembly 20 of the present invention attached to the distal end of comb 30 contacting sheet 11a. Holder assembly 10 has a plurality of sheets 11 stacked or loaded within said holder assembly 10, with sheet 11a being the top or outermost sheet held by holder assembly 10. The upper portion of stacked sheets 11 (including sheet 11a) held within a pocket or pouch formed by lower flap member 12 and cooperating backing member 15 are partially tucked under said upper flap member 13 to secure said sheets in place and prevent unwanted movement of said sheets.

Still referring to FIG. 4, connection bracket member 21 is received on spine member 31 of comb 30 at or near the distal end of said spine member 31. A stylist using said comb 30 as part of the styling process (such as, for example, stylist 100 in FIG. 1) can move said comb 30 toward holder assembly 10 when said stylist is ready to utilize a sheet from stacked plurality of sheets 11. Said stylist can then move tacky substance 23 into contact with sheet 11a. Said tacky substance 23 comprises an easily releasable, pressure sensitive adhesive material that adheres to sheet 11a.

Referring to FIG. 5 (which represents a subsequent stage of the sequential process) as comb 30 and gripper assembly 20 are pulled away from holder assembly 10, sheet 11a remains attached to tacky substance 23 of gripper assembly 20. As said comb 30 and gripper assembly 20 are pulled further away from holder assembly 10, the upper portion of sheet 11a can be dislodged from under upper flap member 13, thereby permitting said sheet 11a to be removed from the pouch formed by lower flap member 12 and cooperating backing member 15. As depicted in FIG. 5, it is possible that sheet 11a can partially deform to further facilitate removal from holder assembly 10.

Referring to FIG. 6 (which represents a subsequent stage of the sequential process), as comb 30 and gripper assembly 20 are pulled yet further away from holder assembly 10, sheet 11a remains adhered to tacky substance 23 of gripper assembly 20. As depicted in FIG. 6, sheet 11a has been completely removed from holder assembly 10, thereby exposing sheet 11b as the top sheet of said plurality of stacked sheets. A stylist can easily remove sheet 11a from gripper assembly 20 and utilize said sheet 11a as part of the styling operation. Thereafter, the process depicted in FIGS. 4 through 6 can then be repeated, such that sheet 11b can be removed from holder assembly 10 for use as desired by a stylist.

Although holder assembly 10 may be placed in any convenient location, said holder assembly can be beneficially disposed against a stylist's body. For example, holder assembly 10 can be suspended from flexible cord member 14 disposed around a stylist's neck so that said holder assembly 10 lies substantially flat against the front of a stylist's torso in an easily accessible location.

The present invention eliminates the need for a stylist to place a stack of sheets on a table, tray, counter or other planar surface. Because the sheets are in a convenient and readily accessible location, a stylist is not required to reach awkwardly over or around a client, thereby reducing the chances for unwanted physical contact with such client. Similarly, the client is not required to handle the sheets and pass same to stylist. Importantly, because the need for separating individual sheets is prevented, overall styling treatment efficiency is improved. Additionally, unnecessary delays that can negatively impact the treatment process are greatly reduced, allowing for improved styling performance.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A method of dispensing sheets used by a stylist for treating hair comprising:
a) holding a plurality of stacked sheets in a location that is easily accessible to a stylist;
b) contacting a first sheet of said plurality of stacked sheets with a gripper device;
c) removing said first sheet from said plurality of stacked sheets, wherein said first sheet is attached to said gripper device;
d) removing said first sheet from said gripper device; and
e) using said first sheet to treat hair.

2. The method of claim 1, further comprising the steps of:
a) contacting a second sheet of said plurality of stacked sheets with a gripper device;
b) removing said second sheet from said plurality of stacked sheets, wherein said first sheet is attached to said gripper device;
c) removing said second sheet from said gripper device; and
d) using said first sheet to treat hair.

3. A method of dispensing sheets used by a stylist for treating hair comprising:
a) holding a plurality of stacked sheets in a holder assembly defining a pouch, wherein said holder assembly is easily accessible to a stylist;
b) contacting a first sheet of said plurality of stacked sheets with a gripper device comprising tacky material;
c) removing said first sheet from said plurality of stacked sheets, wherein said first sheet is attached to said tacky material of said gripper device;
d) removing said first sheet from said tacky material of said gripper device; and
e) using said first sheet to treat hair.

4. The method of claim 3, wherein said gripper device is disposed on a comb.

5. The method of claim 3, wherein said tacky material comprises a solid pressure sensitive adhesive.

6. The method of claim 3, wherein said holder assembly is positioned adjacent to the torso of said stylist.

7. The method of claim 6, wherein said holder assembly further comprises a flexible cord defining a loop.

8. The method of claim 7, wherein said loop of said holder assembly is disposed around the neck of said stylist.
